(19) United States
(12) Patent Application Publication
(10) Pub. No.: US 2025/0337040 A1
(43) Pub. Date: Oct. 30, 2025

(54) BATTERY ASSEMBLY

(71) Applicant: SK On Co., Ltd., Seoul (KR)

(72) Inventors: A Ra JO, Daejeon (KR); Yun Joo NOH, Daejeon (KR)

(21) Appl. No.: 19/189,177

(22) Filed: Apr. 24, 2025

(30) Foreign Application Priority Data
Apr. 25, 2024 (KR) 10-2024-0055332

(51) Int. Cl. H01M 10/653; H01M 10/613; H01M 10/6554; H01M 50/204

(52) U.S. Cl. CPC H01M 10/653; H01M 10/613; H01M 10/6554; H01M 50/204

(57) ABSTRACT

The present disclosure relates to a battery assembly comprising: a case; a cell stack in which a plurality of battery cells are stacked and accommodated inside the case; and a heat dissipation pad disposed between the cell stack and the case and comprising a metal foam layer and at least one insulating layer.

### CROSS-REFERENCE TO RELATED PATENT APPLICATION

The present application claims priority under 35 U.S.C. § 119(a) to Korean patent application number 10-2024-0055332 filed on Apr. 25, 2024, in the Korean Intellectual Property Office, the entire disclosure of which is incorporated by reference herein.

### BACKGROUND OF THE INVENTION

### 1. Field

The present disclosure relates to a secondary battery, and more specifically, to a battery assembly.

### 2. Description of the Related Art

Secondary batteries are batteries that can be charged and discharged multiple times. Secondary batteries may be classified into battery cells and battery assemblies (e.g., battery modules, battery packs, etc.) according to their units. The battery assembly may comprise a plurality of battery cells. On the other hand, when a high-temperature gas or dust is generated in a battery cell in a battery assembly, a stability problem such as accelerating thermal propagation by affecting an adjacent battery cell may occur, and thus a technology for improving stability is required.

According to an aspect, an object of the present disclosure is to provide a battery assembly with improved stability.

The battery pack of the present disclosure can be widely applied to electric vehicles, battery charging stations, and other green technology fields such as solar power generation and wind power generation using batteries. In addition, the battery pack of the present disclosure can be used in eco-friendly electric vehicles, hybrid vehicles, and the like for preventing climate change by suppressing air pollution and greenhouse gas emission.

### SUMMARY OF THE INVENTION

A battery assembly according to an embodiment of the present disclosure may comprise a case; a cell stack in which a plurality of battery cells are stacked and accommodated inside the case; and a heat dissipation pad disposed between the cell stack and the case and comprising a metal foam layer and at least one insulating layer.

In one embodiment, the thickness of the case may be greater than the thickness of the metal foam layer.

In one embodiment, the thickness of the metal foam layer may be greater than the thickness of the insulating layer.

In one embodiment, the thickness of the metal foam layer may be 1.0 mm or more and 2.0 mm or less.

In one embodiment, the thickness of the insulating layer may be 0.1 mm or more and 0.5 mm or less.

In one embodiment, the insulating layer may comprise at least one of glass wool, ceramic wool, and mineral wool.

In one embodiment, the insulating layer comprises at least one of glass wool or ceramic wool, and the insulating layer may further comprise a hydrophobic coating material.

In one embodiment, the hydrophobic coating material may maintain the insulating properties of the insulating layer.

In one embodiment, the insulating layer may comprise at least one property of flame retardancy or flexibility.

In one embodiment, the at least one insulating layer may comprise a first insulating layer and a second insulating layer with the metal foam layer interposed therebetween.

In one embodiment, the heat dissipation pad may comprise a first adhesive layer positioned between an upper side of the first insulating layer and a lower side of the metal foam layer, and a second adhesive layer positioned between the upper side of the metal foam layer and the lower side of the second insulating layer.

In one embodiment, the metal foam layer may comprise a plurality of pores, and wherein a high-temperature gas generated from at least one battery cell among the plurality of battery cells passes through the metal foam layer through at least one of the plurality of pores.

In one embodiment, the temperature of the gas after passing through the metal foam layer may be lower than the temperature of the gas before passing through the metal foam layer.

In one embodiment, the case may comprise a body supporting the cell stack and a cover coupled to the body and accommodating the cell stack together with the body, and wherein the heat dissipation pad is arranged closer to the cover than the cell stack.

In one embodiment, the at least one insulating layer may include a first insulating layer and a second insulating layer with the metal foam layer interposed therebetween, and wherein the heat dissipation pad may transfer a heat generated in at least one battery cell among the plurality of battery cells to the cover through the first insulating layer, the metal foam layer and the second insulating layer.

In one embodiment, the case may further comprise an endplate disposed between the cover and the body and surrounding the side of the cell stack and the heat dissipation pad.

In one embodiment, the thickness of the cover may be greater than the thickness of the metal foam layer.

In one embodiment, the thickness of the metal foam layer may be greater than the thickness of the first insulating layer.

According to an embodiment, the present disclosure can provide a battery assembly with improved stability.

According to an embodiment, the present disclosure can provide a battery assembly with improved thermal stability.

According to an embodiment, the present disclosure can minimize thermal conduction of the battery assembly.

According to an embodiment, the present disclosure may delay the occurrence of a fire in the battery assembly.

### BRIEF DESCRIPTION OF THE DRAWINGS

FIG. 1 illustrates a diagram for explaining a battery assembly according to an embodiment.

FIG. 2 is an exploded view of a heat dissipation pad according to an embodiment.

FIG. 3 is a cross-sectional view of the heat dissipation pad according to an embodiment.

FIG. 4 is a cross-sectional view of a heat dissipation pad according to another embodiment.

FIG. 5 is a cross-sectional view for explaining a battery assembly according to an embodiment.

### DETAILED DESCRIPTION

Hereinafter, referring to the accompanying drawings, embodiments of the present disclosure are described in detail so that those skilled in the art to which the present disclosure pertains can easily practice them. However, the present disclosure may be implemented in a number of different forms and is not limited to the embodiments described herein. Further, in order to clearly explain the present disclosure in the drawings, parts that are not related to the explanation are omitted, and similar parts are given similar reference numerals throughout the specification.

In order to explain the present disclosure, a spatial orthogonal coordinate system based on the X-axis, the Y-axis, and the Z-axis orthogonally to each other will be described below. Unless otherwise specified, the Z direction refers to the height direction, and the X direction (or the first direction) refers to any one of the directions perpendicular to the height direction. The Y direction (or the second direction) means a direction perpendicular to the Z direction and the X direction.

However, the X-direction, Y-direction, and Z-direction mentioned below are intended to explain the present disclosure so that it can be clearly understood, and it goes without saying that each direction may be defined differently depending on where the standard is placed.

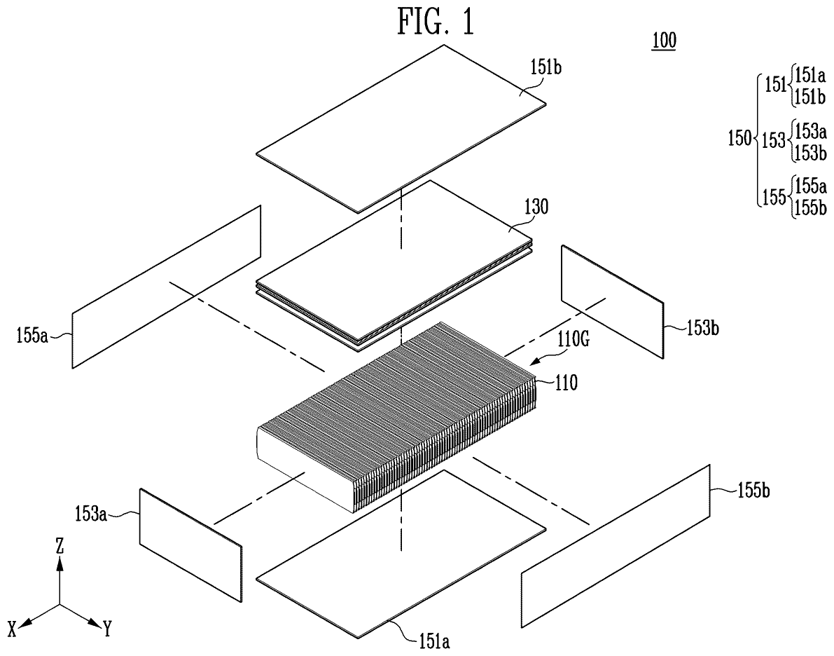

FIG. 1 illustrates a diagram for explaining a battery assembly according to an embodiment.

Referring to FIG. 1, a battery assembly 100 according to an embodiment of the present disclosure may include a cell stack 110G, a heat dissipation pad 130, and a case 150. For example, the battery assembly 100 may correspond to various devices such as a battery module, a battery pack, or an energy storage system (ESS).

The cell stack 110G may be accommodated inside the case 150. For example, the interior of the case 150 may be a space surrounded by the case 150.

The cell stack 110G may include a plurality of battery cells 110. In an embodiment, the plurality of battery cells 110 may be stacked along the first horizontal direction. For example, the first horizontal direction may be the X-axis direction. In other embodiments, the plurality of battery cells 110 may be stacked along the height direction. For example, the height direction may be the Z-axis direction. Each of the plurality of battery cells 110 may be a secondary battery capable of being charged and discharged a plurality of times. For example, the secondary battery may be one of various types such as a lithium cobalt battery, a lithium high nickel battery, a lithium iron phosphate battery, a lithium ion battery, a lithium polymer battery, a lithium sulfur battery, a nickel hydrogen battery, a nickel cadmium battery, a sodium battery, and an all-solid-state battery. The type of the battery cell 110 may be one of a pouch type, a cylindrical type, and a square type, which are classified according to a packaging type. In an embodiment, the battery assembly 100 may further include a bus-bar electrically connecting the plurality of battery cells 110.

The heat dissipation pad 130 may be disposed between the cell stack 110G and the case 150. The heat dissipation pad 130 may disperse a heat generated in at least one battery cell among the plurality of battery cells 110 and transfer the heat to the case 150. The heat dissipation pad 130 may reduce the conduction of the heat generated in a particular battery cell to an adjacent battery cell. Accordingly, it is possible to mitigate the generation or propagation of flames caused by heat. For example, the heat dissipation pad 130 may be disposed between the cell stack 110G and the case 150 along the height direction of the case 150.

The case 150 may include at least one of a baseplate 151, an endplate 153, and a sideplate 155. In an embodiment, the base plate 151 may be coupled to at least one of the endplate 153 and the side plate 155 by means of bolting, welding, or the like. In an embodiment, the baseplate 151 may include a body 151a and a cover 151b. The

body 151a and the cover 151b may be disposed below and above the cell stack 110G in the height direction (e.g., the Z-axis direction) respectively. The body 151a may support the cell stack 110G. The body 151a may surround the lower side of the cell stack 110G. The cover 151b may surround the upper side of the cell stack 110G.

In an embodiment, the heat dissipation pad 130 may be disposed between the cell stack 110G and the cover 151b. For example, the heat dissipation pad 130 may be positioned on an upper side of the cell stack 110G, and the cover 151b may be positioned on the upper side of the heat dissociation pad 130. In another embodiment, the heat dissipation pad 130 may be disposed between the cell stack 110G and the body 151a. For example, the heat dissipation pad 130 may be disposed below the cell stack 110G, and the body 151a may be disposed under the heat dissociation pad 130. However, this is only an embodiment, and the position of the heat dissipation pad 130 may be variously modified and implemented.

In an embodiment, the endplate 153 may surround the cell stack 110G and the side of the heat dissipation pad 130 with respect to the first horizontal direction (e.g., X-axis direction). That is, the endplate 153 may be positioned at both ends of the cell stack 110G along the same stacking direction as the cell stack 110 G. The endplate 153 may be disposed between the cover 151b and the body 151a. In an embodiment, the endplate 153 may include a first endplate 153a and a second endplate 153b positioned on both sides of the cell stack 110G in a first horizontal direction (e.g., X-axis direction). The endplate 153 may apply a surface pressure to the cell stack 110G in a first horizontal direction (e.g., the X-axis direction).

In an embodiment, the sideplate 155 may surround a side of the cell stack 110G in a second horizontal direction (e.g., the Y-axis direction). The sideplate 155 may be disposed between cover 151b and body 151a. In an embodiment, the sideplate 155 may include a first sideplate 155a and a second sideplate 155b positioned on both sides of the cell stack 110G in a second horizontal direction (e.g., the Y-axis direction).

The case 150 may have a predetermined thickness. The base plate 151, the endplate 153, and the side plate 155 may each have a predetermined thickness.

In an embodiment, the base plate 151, the endplate 153, and the side plate 155 may each have different thicknesses. Alternatively, the base plate 151, the endplate 153, and the side plate 155 may have the same thickness.

In an embodiment, the cover 151b and the body 151a may each have different thicknesses. Alternatively, they may have the same thickness.

In embodiments, the first endplate 153a and the second endplate 153b may each have different thicknesses. Alternatively, they may have the same thickness.

In embodiments, the first sideplate 155a and the second sideplate 155b may each have different thicknesses. Alternatively, they may have the same thickness.

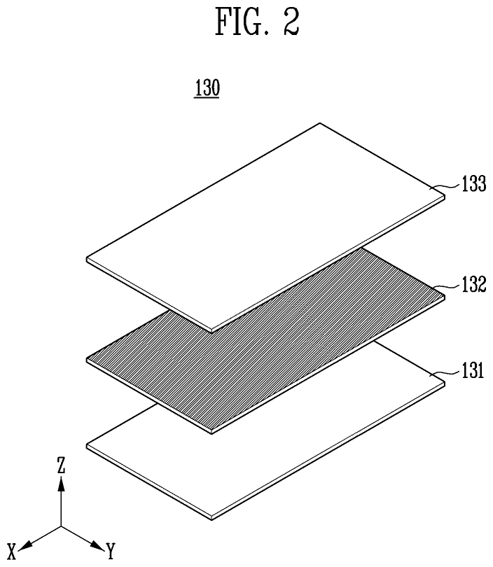

FIGS. 2 to 4 illustrate diagrams for explaining a heat dissipation pad according to an embodiment.

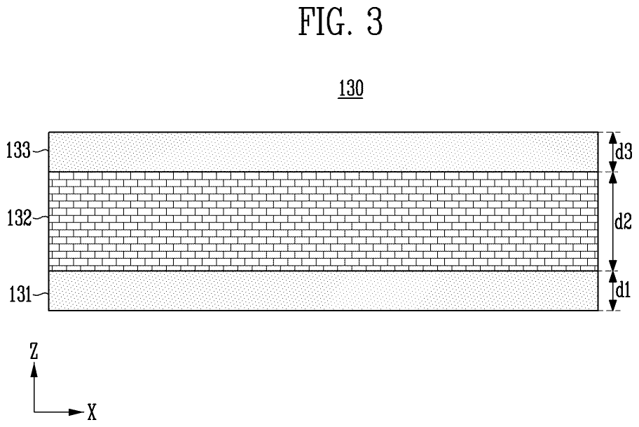

FIG. 2 is an exploded view of a heat dissipation pad according to an embodiment, and FIG. 3 is a cross-sectional view of the heat dissipation pad according to an embodiment.

Referring to FIGS. 2 and 3, the heat dissipation pad 130 may include a metal foam layer 132 and at least one insulating layer 131, 133.

The metal foam layer 132 may be positioned on one side of the at least one insulating layer 131, 133. In an embodiment, the at least one insulating layer 131, 133 may include a first insulating layer 131 and a second insulating layer 133 with the metal foam layer 132 interposed therebetween. That is, the metal foam layer 132 may be disposed between the first insulating layer 131 and the second insulating layer 133. Referring to FIGS. 1 to 3, the first insulating layer 131 may be disposed between the cell stack 110G and the metal foam layer 132. For example, the first insulating layer 131 may be disposed between an upper side of the cell stack 110G and a lower side of the metal foam layer 132. The second insulating layer 133 may be disposed between the metal foam layer 132 and the case 150. For example, the second insulating layer 133 may be disposed above the metal foam layer 132 and below the cover 151b of the case 150.

The at least one insulating layer 131, 133 may have insulating properties. In an embodiment, the at least one insulating layer 131, 133 may include a first insulating layer 131 and a second insulating layer 133. Each of the first insulating layer 131 and the second insulating layer 133 may have an insulating property. Here, the insulating property may indicate a property of blocking the electrical connection between the two objects. For example, the first insulating layer 131 may electrically separate the cell stack 110G (or the battery cell) and the metal foam layer 132. The second insulating layer 133 may electrically separate the metal foam layer 132 and the case 150.

In embodiments, the properties of the at least one insulating layer 131, 133 may further include at least one of flame retardancy or flexibility. In an embodiment, the at least one insulating layer 131, 133 may include a first insulating layer 131 and a second insulating layer 133. The properties of each of the first insulating layer 131 and the second insulating layer 133 may further include at least one of flame retardancy or flexibility. Flame retardancy may exhibit properties that are difficult to burn. Flexibility can exhibit the property of elastically deforming and returning to its original shape when the applied stress is removed. In an embodiment, each of the first insulating layer 131 and the second insulating layer 133 may include an elastic material. In this case, each of the first insulating layer 131 and the second insulating layer 133 may have flexibility. In addition, each of the first insulating layer 131 and the second insulating layer 133 can minimize damage to the battery cell due to vibration or impact

In an embodiment, the metal foam layer 132 may include at least one of a variety of metal materials. For example, the metal foam layer 132 may include at least one of nickel, copper, iron, gold, silver, and aluminum.

In an embodiment, the metal foam layer 132 may have properties of porosity and high thermal conductivity. Porosity may refer to a structural property in which a large number of pores of fine size are formed on the surface or inside of an object. For example, the pores may have a size in nanometers or micrometers. Thermal conductivity can indicate the ability to transfer heat from an object to another object. The metal foam layer 132 may have a thermal conductivity greater than or equal to a reference value. For example, the unit of thermal conductivity may be W/mK. That is, since the volume of the pores is large compared to the total volume of the metal foam layer 132, excellent heat exchange properties can be obtained.

In an embodiment, the pores of the metal foam layer 132 may serve as a passageway for gas (or particles). In other words, gas can be moved through the pores. When the gas passes through the pores of the metal foam layer 132, heat exchange may occur due to the high thermal conductivity of the metal foam layers 132, and the temperature of the gas may be rapidly reduced. In this case, the temperature of the gas may be reduced below the ignition point. Thereby, the generation or propagation of flames can be minimized.

In an embodiment, the pore structure allows the metal foam layer 132 to reduce noise due to vibration or impact. In an embodiment, the low-density metal foam layer 132 may reduce the weight of the battery assembly 100.

The thickness of the case 150 may be greater than the thickness of the metal foam layer 132. In an embodiment, the heat dissipation pad 130 may be disposed between the cell stack 110G and the case 150. A thickness of the case 150 facing the cell stack 110G may be greater than a thickness of the metal foam layer 132.

In an embodiment, the case 150 may include a body 151a and a cover 151b. A heat dissipation pad 130 may be disposed between the cover 151b and the cell stack 110G. The thickness of the cover 151b may be greater than the thickness of the metal foam layer 132. In addition, a heat dissipation pad 130 may be disposed between the body 151a and the cell stack 110G. The thickness of the body 151a may be greater than the thickness of the metal foam layer 132.

In an embodiment, the thickness d2 of the metal foam layer 132 may be greater than the thicknesses d1, d3 of the at least one insulating layer 131, 133. For example, the thickness d2 of the metal foam layer 132 may be greater than the thicknesses d1 and d3 of the first insulating layer 131 and the second insulating layer 133, respectively. That is, the thickness d2 of the metal foam layer 132 may be greater than the thickness d1 of the first insulating layer 131. The thickness d2 of the metal foam layer 132 may be greater than the thickness d3 of the second insulating layer 133. Here, the thickness may be a length in the height direction (e.g., the Z-axis direction). By designing the thicknesses d1 and d3 of the first insulating layer 131 and the second insulating layer 133 to be smaller than the thickness d2 of the metal foam layer 132, it is possible to relatively quickly transfer the heat transferred to the first insulating layer 131 or the second insulating layer 133 to the metal foam layer 132 or the case 150.

In an embodiment, the thickness d2 of the metal foam layer 132 may be greater than or equal to 1.0 mm and less than or equal to 2.0 mm. When the thickness d2 of the metal foam layer 132 is large, the energy density may be low, and when the thickness d2 is low, the heat dissipation effect may be low.

In an embodiment, the thicknesses d1, d3 of the at least one insulating layer 131, 133 may be greater than or equal to 0.1 mm and less than or equal to 0.5 mm. For example, the thicknesses d1 and d3 of each of the first insulating layer 131 and the second insulating layer 133 may be 0.1 mm or more and 0.5 mm or less. That is, the thickness d1 of the first insulating layer 131 may be 0.1 mm or more and 0.5 mm or less. The thickness d3 of the second insulating layer 133 may be 0.1 mm or more and 0.5 mm or less. The thickness d1 of the first insulating layer 131 and the thickness d3 of the second insulating layer 133 may be the same as or different from each other. When the thicknesses d1 and d3 of the first insulating layer 131 and the second insulating layer 133 are large, heat transfer may be slowed and thermal energy may be retained or increased. When the thicknesses d1 and d3 of the first insulating layer 131 and the second insulating layer 133 are small, properties such as insulation property may not be exhibited.

Consequently, in the battery assembly of the present disclosure, the thickness of the case 150 may be greater than the thickness of the metal foam layer 132, and the thickness of the metal foam layer 132 may be greater than a thickness of at least one insulating layer.

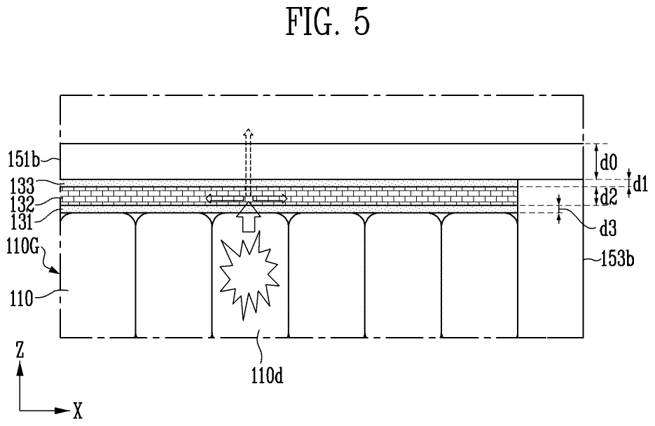

In an embodiment, referring to FIG. 5, a thickness d0 of the cover 151b may be greater than a thickness d2 of the metal foam layer 132, and the thickness d2 of a metal foam layer 132 may be greater than thicknesses d1 and d3 of at least one insulating layer.

In an embodiment, the at least one insulating layer 131, 133 may include at least one of glass wool, ceramic wool, and mineral wool. For example, each of the first insulating layer 131 and the second insulating layer 133 may include at least one of glass wool, ceramic wool, and mineral wool. That is, the first insulating layer 131 may include at least one of glass wool, ceramic wool, and mineral wool. The second insulating layer 133 may include at least one of glass wool, ceramic wool, and mineral wool. The material of the first insulating layer 131 and the material of the second insulating layer 133 may be the same as or different from each other.

The glass wool may comprise a fiber-structured glass material. The ceramic wool may comprise a fibrous ceramic material. For example, the ceramic material may comprise silica and alumina. The mineral wool may include fibrous mineral materials. For example, the mineral material may comprise at least one of a natural mineral material and a synthetic mineral material. In an embodiment, each of the glass wool, ceramic wool, and mineral wool may be prepared by melting the material to produce fibers using centrifugation, air compression, or the like, and then weaving or compressing the fibers. In an embodiment, the glass wool, ceramic wool, and mineral wool may have electrical insulation due to the inorganic material. In an embodiment, glass wool, ceramic wool, and mineral wool may have flexibility due to their fiber structure and may have sound absorbing property that absorbs noise. In embodiments, glass wool, ceramic wool, and mineral wool may have flame retardancy and/or fire resistance.

In an embodiment, the at least one insulating layer 131, 133 may further comprise a hydrophobic coating material if it comprises one of glass wool or ceramic wool. For example, each of the first insulating layer 131 and the second insulating layer 133 may include one of glass wool or ceramic wool. In this case, each of the first insulating layer 131 and the second insulating layer 133 may further include a hydrophobic coating material. The hydrophobic coating material may include a material having hydrophobicity that is not easily bonded to water molecules. For example, the hydrophobic coating material may include at least one of a fluoropolymer, silicone, a perfluorinated compound, and a hydrophobic polymer. The hydrophobic coating material may be coated on the surface of each of the first insulating layer 131 and the second insulating layer 133, or may be coated as a whole from the surface to the inside of the layer of each of the first insulating layer 131 and second insulating layer 133.

In an embodiment, when each of the first insulating layer 131 and the second insulating layer 133 includes mineral wool, a separate hydrophobic coating material may not be included. This is because mineral wool has hydrophobic properties.

In an embodiment, the hydrophobic coating material may maintain insulating properties of each of the first insulating layer 131 and the second insulating layer 133 in a high humidity environment. A high humidity environment may mean an environment in which humidity is equal to or higher than a reference value.

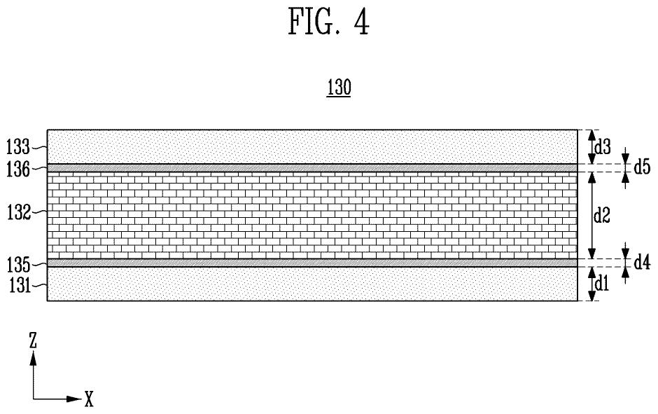

FIG. 4 is a cross-sectional view of a heat dissipation pad according to another embodiment.

Referring to FIG. 4, the heat dissipation pad 130 according to another embodiment may further include a first adhesive layer 135 and a second adhesive layer 136.

The first adhesive layer 135 may be positioned between an upper side of the first insulating layer 131 and a lower side of the metal foam layer 132. The first adhesive layer 135 can fix the first insulating layer 131 and the metal foam layer 132 to each other by adhesive force. The second adhesive layer 136 may be positioned between an upper side of the metal foam layer 132 and a lower side of the second insulating layer 133. The second adhesive layer 136 can fix the metal foam layer 132 and the second insulating layer 133 to each other by adhesive force. Each of the first adhesive layer 135 and the second adhesive layer 136 may be coated with a single layer of an adhesive material or may be provided with double-sided tape.

In an embodiment, the thickness d4 of the first adhesive layer 135 and the thickness d5 of the second adhesive layer 136 may be less than the thickness d2 of the metal foam layer 132. In an embodiment, the thickness d4 of the first adhesive layer 135 and the thickness d5 of the second adhesive layer 136 may be less than the thicknesses d1, d3 of the first insulating layer 131 and the second insulating layer 133, respectively.

FIG. 5 is a cross-sectional view for explaining a battery assembly according to an embodiment. FIG. 5 also illustrates a partial cross-section of the battery assembly.

Referring to FIGS. 1 and 5, the battery assembly 100 may include a cell stack 110G, a heat dissipation pad 130, and a case 150. The case 150 may include a body 151a, a cover 151b, and an endplate 153. The endplate 153 includes a first endplate 153a and a second endplate 153b, and the endplate 153 is arranged between the cover 151b and the body 151a, and may surround the cell stack 110G and the side of the heat dissipation pad 130.

The heat dissipation pad 130 may be positioned between the cell stack 110G and the cover 151b. The heat dissipation pad 130 may include a first insulating layer 131, a metal foam layer 132, and a second insulating layer 133.

In an embodiment, a plurality of pores may be formed in the metal foam layer 132. The size of the pores may be in nanometers or micrometers. The cell stack 110G may include a plurality of battery cells 110. A high-temperature gas (or flame, etc.) may be generated in a specific battery cell 110d among a plurality of battery cells 110. High-temperature gas generated in the specific battery cell 110d of the plurality of battery cells 110 may pass through the metal foam layer 132 through at least one of the plurality of pores.

In an embodiment, the temperature of the gas after passing through the metal form layer 132 may be reduced from the temperature of the gases before passing through the metal foam layer 132. That is, heat may be dispersed by heat exchange while the gas passes through the metal foam layer 132, thereby lowering the temperature of the gas.

In an embodiment, the heat dissipation pad 130 may transfer a portion of heat generated in at least one battery cell among the plurality of battery cells to the cover 151b through the first insulating layer 131, the metal foam layer 132, and the second insulating layer 133.

In an embodiment, the hot gas may move to the metal foam layer 132 through the gap in the first insulating layer 131. The gas may move through the pores of the metal foam layer 132 into the interior of the metal foam layers 132 or into the second insulating layer 133. In this case, heat of the gas may be dispersed within the metal foam layer 132. In another embodiment, the hot gas may not be moved to the metal foam layer 132 by the first insulating layer 131, and heat of the gas may be transferred to the metal foam layers 132 through the first insulating layers 131. In this case, the gas inside the metal foam layer 132 moves through the pores and heat can be dispersed.

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. A battery assembly comprising:
a case;
a cell stack in which a plurality of battery cells are stacked and accommodated inside the case; and
a heat dissipation pad disposed between the cell stack and the case and comprising a metal foam layer and at least one insulating layer.

2. The battery assembly according to claim 1, wherein the thickness of the case is greater than the thickness of the metal foam layer.

3. The battery assembly according to claim 1, wherein the thickness of the metal foam layer is greater than the thickness of the insulating layer.

4. The battery assembly according to claim 3, wherein the thickness of the metal foam layer is 1.0 mm or more and 2.0 mm or less.

5. The battery assembly according to claim 3, wherein the thickness of the insulating layer is 0.1 mm or more and 0.5 mm or less.

6. The battery assembly according to claim 1, wherein the insulating layer comprises at least one of glass wool, ceramic wool, and mineral wool.

7. The battery assembly according to claim 1, wherein the insulating layer comprises at least one of glass wool or ceramic wool, and the insulating layer further comprises a hydrophobic coating material.

8. The battery assembly according to claim 7, wherein the hydrophobic coating material maintains the insulating properties of the insulating layer.

9. The battery assembly according to claim 1, wherein the insulating layer comprises at least one property of flame retardancy or flexibility.

10. The battery assembly according to claim 1, wherein the at least one insulating layer comprises a first insulating layer and a second insulating layer with the metal foam layer interposed therebetween.

11. The battery assembly according to claim 10, wherein the heat dissipation pad comprises a first adhesive layer positioned between the upper side of the first insulating layer and the lower side of the metal foam layer, and a second adhesive layer positioned between the upper side of the metal foam layer and the lower side of the second insulating layer.

12. The battery assembly according to claim 1, wherein the metal foam layer comprises a plurality of pores, and wherein a high-temperature gas generated in at least one battery cell among the plurality of battery cells passes through the metal foam layer through at least one of the plurality of pores.

13. The battery assembly according to claim 12, wherein the temperature of the gas after passing through the metal foam layer is smaller than the temperature of the gas before passing through the metal foam layer.

14. The battery assembly according to claim 1, wherein the case comprises a body supporting the cell stack and a cover coupled to the body and accommodating the cell stack together with the body, and wherein the heat dissipation pad is arranged closer to the cover than the cell stack.

15. The battery assembly according to claim 14, wherein the at least one insulating layer comprises a first insulating layer and a second insulating layer with the metal foam layer interposed therebetween, and wherein the heat dissipation pad transfers a heat generated in at least one battery cell among the plurality of battery cells to the cover through the first insulating layer, the metal foam layer and the second insulating layer.

16. The battery assembly according to claim 14, wherein the case further comprises an endplate disposed between the cover and the body and surrounding the side of the cell stack and the heat dissipation pad.

17. The battery assembly according to claim 14, wherein the thickness of the cover is greater than the thickness of the metal foam layer.

18. The battery assembly according to claim 15, wherein the thickness of the metal foam layer is greater than the thickness of the first insulating layer.
